(19) United States
(12) Patent Application Publication
(10) Pub. No.: US 2008/0196004 A1
(43) Pub. Date: Aug. 14, 2008

(54) APPARATUS AND METHOD FOR DEVELOPING COMPONENT-BASED SOFTWARE

(75) Inventors: YOON-HEE CHOI, Suwon-si (KR); Chong-mok Park, Seoul (KR); Kyung-sub Min, Seoul (KR); Seok-jin Hong, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/848,647

(22) Filed: Aug. 31, 2007

(30) Foreign Application Priority Data
Feb. 14, 2007 (KR) 2007-15485

(51) Int. Cl. G06F 9/44

(52) U.S. Cl. 717/107; 717/120

(57) ABSTRACT

An apparatus and method for developing component-based software, and more particularly, an apparatus and method for developing component-based software in order to define an identified component in a component language and reuse the identified component. The apparatus includes a component division module to analyze source code and a build file and to divide the analyzed source code and build file into a build-level component and a functional-level component; an integrity check module to check the integrity of languages defining the build-level component, the functional-level component, and an interface of the functional-level component; and a component combination module to combine one or more build-level components corresponding to one or more functional-level components that form an architecture.

### CROSS-REFERENCE TO RELATED APPLICATION

This application claims the benefit of Korean Patent Application No. 2007-15485 filed in the Korean Intellectual Property Office on Feb. 14, 2007, the disclosure of which is incorporated herein by reference.

### BACKGROUND OF THE INVENTION

1. Field of the Invention

Aspects of the present invention relate to an apparatus and method for developing component-based software, and more particularly, to an apparatus and method for developing component-based software in order to define an identified component in a component language and reuse the identified component.

2. Description of the Related Art

The emergence of digital convergence products is diversifying consumer electronics (CE) products and rapidly increasing the capacity of software built in the CE products. Characteristically, software of convergence products can be used in various products after a little modification while the function of the software remains unchanged. Generally, source code of software that constitutes a CE product is almost identical to source code of conventional software. Therefore, if conventional software is fully reused and an additional function is newly developed, a very large gain may be obtained in terms of software development time and costs.

FIG. 1 is a flowchart illustrating a conventional method of developing software. A model of software is defined based on requirements of a client (operation S11). Based on the demand model, the structure of the software is designed by representing functions of the software as relationships between components (operation S12). The components are divided based on the structure of the software and the functions of the components are specified in detail (operation S13). A target platform that will run an application after receiving the detailed design of the software is designated, and corresponding code is generated (operation S14). An application is generated by building the generated code (operation S15).

In the conventional method of developing software, source code is generated from an object-oriented model. Therefore, the method cannot be applied to software that is developed without considering object orientation. In addition, since the conventional method supports top-down development only, the conventional method does not provide an integrity check function useful for bottom-up development in which existing source code is changed into components.

The component object model (COM) suggested by Microsoft Corporation supports binary components and runs on Windows-based operating systems only. As a result, the COM is not suitable for a CE environment that supports various platforms. KOALA is a component model developed by Philips Electronics and a model for CE software. However, due to a limitation on a function name, existing source code must be modified according to the model so that the source code can be reused.

Korean Patent Publication No. 2003-0021554 discloses an application program implementation system and method that changes a repository-based application program into components, manages and reuses the components, and enables cooperative development between geographically distributed developers. However, this invention fails to suggest a method of applying to various platforms using a component model that supports components in the form of the source code, and suggest the integrity check function in bottom-up development.

### SUMMARY OF THE INVENTION

Aspects of the present invention provide an apparatus and method for developing component-based software, the apparatus and method capable of easily transplanting a component to various environments by separately managing logical and physical functions of the component.

Aspects of the present invention also provide an apparatus and method for developing component-based software, the apparatus and method capable of developing stable software by checking the integrity of a component when the component is generated and thus preventing an error which may occur when the component is combined with another component.

According to an aspect of the present invention, an apparatus for developing component-based software is provided. The apparatus includes a component division module to analyze source code and a build file and to divide the analyzed source code and build file into a build-level component and a functional-level component; an integrity check module to check the integrity of languages defining the build-level component, the functional-level component, and an interface of the functional-level component; and a component combination module to combine one or more build-level components respectively corresponding to one or more functional-level components that form an architecture.

According to another aspect of the present invention, a method of developing component-based software is provided. The method includes analyzing source code and a build file and dividing the analyzed source code and build file into a build-level component and a functional-level component; checking the integrity of languages defining the build-level component, the functional-level component, and an interface of the functional-level component; and combining one or more build-level components corresponding to one or more functional-level components that form an architecture.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a conventional method of developing software;

FIG. 2 is a block diagram of an apparatus for developing component-based software according to an embodiment of the present invention;

FIG. 3 illustrates a build-level component definition language (BCDL) defining a build-level component according to an embodiment of the present invention;

FIG. 4 illustrates a component definition language (CDL) defining a functional-level component according to an embodiment of the present invention;

FIG. 5 illustrates an interface definition language (IDL) defining an interface of a functional-level component according to an embodiment of the present invention;

FIG. 6 is a schematic diagram illustrating an error that occurs between the IDL and source code when an interface attribute is “provision” according to an embodiment of the present invention;

FIG. 7 is a schematic diagram illustrating an error that occurs between the IDL and the source code when the interface attribute is “demand” according to an embodiment of the present invention;

FIG. 8 illustrates a CDL defining a synthesis functional-level component according to an embodiment of the present invention;

FIG. 9 illustrates a BCDL defining a synthesis build-level component according to an embodiment of the present invention;

FIG. 10 is a flowchart illustrating a method of generating a functional-level component according to an embodiment of the present invention;

FIG. 11 is a flowchart illustrating a method of generating a build-level component according to an embodiment of the present invention; and

FIG. 12 is a flowchart illustrating a method of generating a synthesis component according to an embodiment of the present invention.

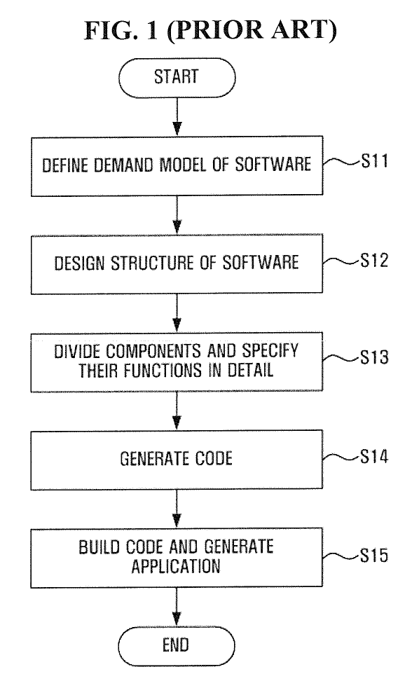

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

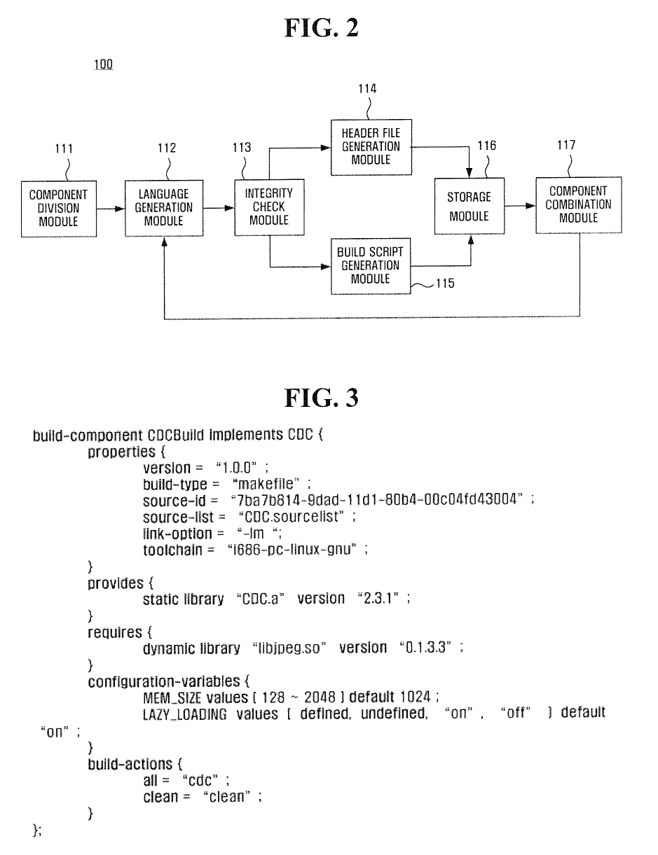

FIG. 2 is a block diagram of an apparatus 100 for developing component-based software according to an embodiment of the present invention. The apparatus 100 includes a component division module 111, a language generation module 112, an integrity check module 113, a header file generation module 114, a build script generation module 115, a storage module 116, and a component combination module 117. The apparatus 100 according to other aspects of the invention may include additional or different components.

The component division module 111 analyzes source code and a build file and divides the source code and the build file into a build-level component and a functional-level component. The build-level component is a physically expressed software component including a source file, a library, and a build script required to build the source file and the library in various configurations. The build-level component may provide a configuration interface and a build interface to facilitate easy application and building of configurations. The configuration interface may be used to change the configuration of the build-level component. The configuration of the component can be changed at build time by setting a value of a variable parameter. In addition, the build interface may execute a build action of the build-level component. The build action denotes a target name described in a build script file and may be understood as “all,” “clean,” and “install.” The source code may be written in any programming language, including C or C++.

The functional-level component is a software component expressing a logical function of the component. The functional-level component may provide a plurality of interfaces in units of which logical functions are provided. Since the same logical function can be implemented using a plurality of algorithms, a functional-level component can be implemented as a plurality of build-level components. In addition, since build-level components are implemented in units of builds defined in the source code, a build-level component can be implemented as a plurality of functional-level components.

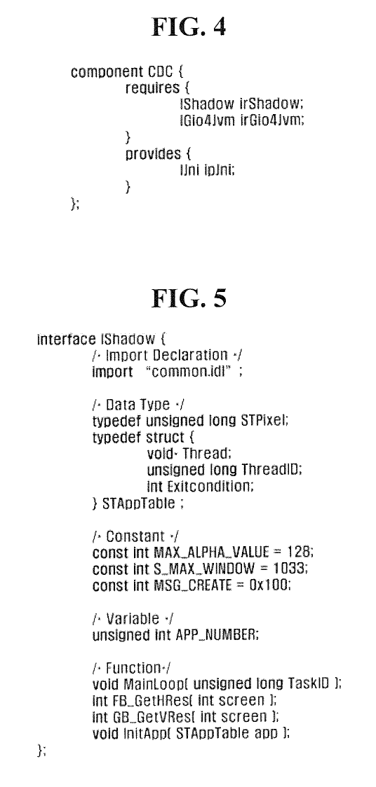

The language generation module 112 generates languages defining the build-level component, the functional-level component, and the interfaces of the functional-level component. The language generation module 112 may use a build-level component definition language (BCDL) defining the build-level component as illustrated in FIG. 3. The BCDL describes an identification (ID), name, attribute and version of a build-level component; a configuration interface required to divide source code into a component and build the component; a build interface; a source tree; and a library. In addition, the language generation module 112 may use a component definition language (CDL) to define the functional-level component as illustrated in FIG. 4. The CDL describes an ID and name of a functional-level component and interfaces required or provided by the functional-level component. The language generation module 112 may also use an interface definition language (IDL) to define the interfaces required or provided by the functional-level component as illustrated in FIG. 5. The IDL describes functions and global variables contained in the interfaces. The functions are function execution units. The particular structure or format of the various languages as shown in the figures is not limiting, and it is understood that the various languages may be expressed using any structure or format.

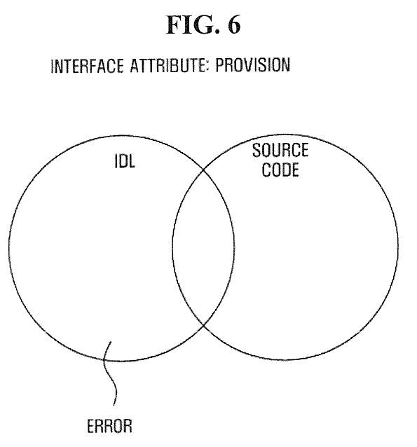

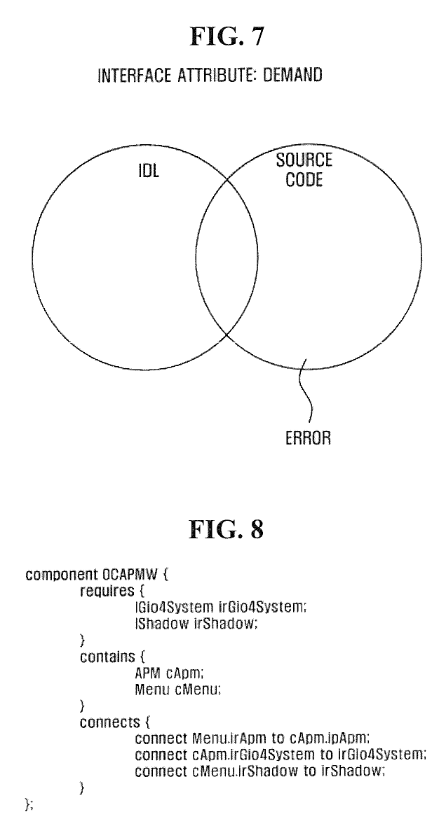

The integrity check module 113 checks the integrity of the BCDL, the CDL, and the IDL generated by the language generation module 112. For example, if an interface attribute is ‘provision’ as illustrated in FIG. 6, if the IDL specifies an interface that is not implemented in source code, an error may occur. If the interface attribute is ‘demand’ as illustrated in FIG. 7, if the source code uses a symbol that is not specified in IDL, an error may also occur.

The integrity check module 113 may also perform a compatibility check and a symbol name collision check. The compatibility check determines whether components can be exchanged with each other and used accordingly or whether different interfaces can be connected to each other. The symbol name collision check determines whether interfaces exist having the same symbol name among components that form a synthesis component. Synthesis components will be described further below.

The header file generation module 114 may generate a header file using the CDL and the IDL described above. The build script generation module 115 may generate a wrapper build script file, which can build the build-level component, using the BCDL described above. The wrapper build script file is for reusing a build script file existing in conventional source code such as C or C++. The wrapper build script file is used to build the build-level component while maintaining an existing build script file as is.

The build script generation module 115 performs a build test using the wrapper build script file by applying various configurations to the build-level component. Components that pass the build test may be packaged and stored in the storage module 116.

The component combination module 117 combines a synthesis build-level component composed of one or more build-level components with a synthesis functional-level component composed of one or more functional-level components using build-level components and functional-level components stored in the storage module 116. A case where the synthesis build-level component is combined based on the synthesis functional-level component is described as an example. However, the present invention is not limited thereto. A reverse case, in which a synthesis functional-level component is combined based on a synthesis build-level component, may also be used.

The component combination module 117 may extract one or more functional-level components required to implement a new component from the storage module 116. In addition, the component combination module 117 may check the dependence of the extracted functional-level components. The dependence check checks components depended on by the extracted functional-level components to execute.

After the dependence check, the language generation module 112 generates the CDL describing the extracted functional-level components. After the integrity check module 113 performs the integrity check and the compatibility check, the component combination module 117 generates a synthesis functional-level component from the extracted functional-level components. FIG. 8 illustrates a CDL defining the generated synthesis functional-level component according to an embodiment of the present invention.

The component combination module 117 may also generate a synthesis build-level component based on the generated synthesis functional-level component. In this case, the component combination module 117 may extract build-level components corresponding to functional-level components that form the synthesis functional-level component from the storage module 116, bind the extracted build-level components with the functional-level components of the synthesis functional-level component, and check the dependence of the extracted build-level components.

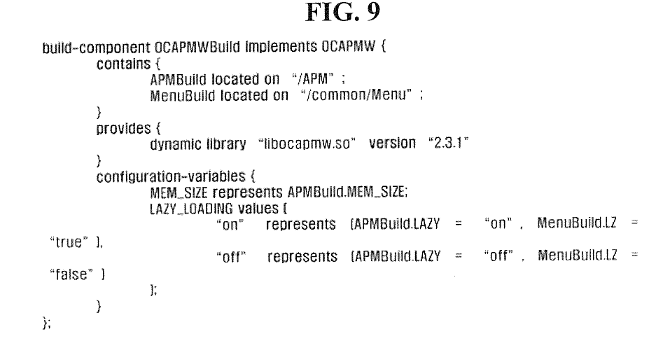

After the dependence of the extracted build-level component is checked, the integrity check module 113 checks the integrity and compatibility of the extracted build-level components. In addition, the component combination module 117 may generate a synthesis build-level component from the extracted build-level components. FIG. 9 illustrates a BCDL defining the generated synthesis build-level component according to an embodiment of the present invention. The component combination module 117 may bind the generated synthesis build-level component with the generated synthesis functional-level component.

In addition, the build script generation module 115 may generate a wrapper build script file for the synthesis build-level component and perform a build test by applying various configurations. After the build test is performed, the component combination module 117 may package a synthesis component, in which the synthesis functional-level component is bound, with the synthesis build-level component and store the packaged synthesis component in the storage module 116, or may generate an execution file to be used on a target platform. The target platform may be a mobile device, desktop computer, embedded device (e.g., a router), or a server.

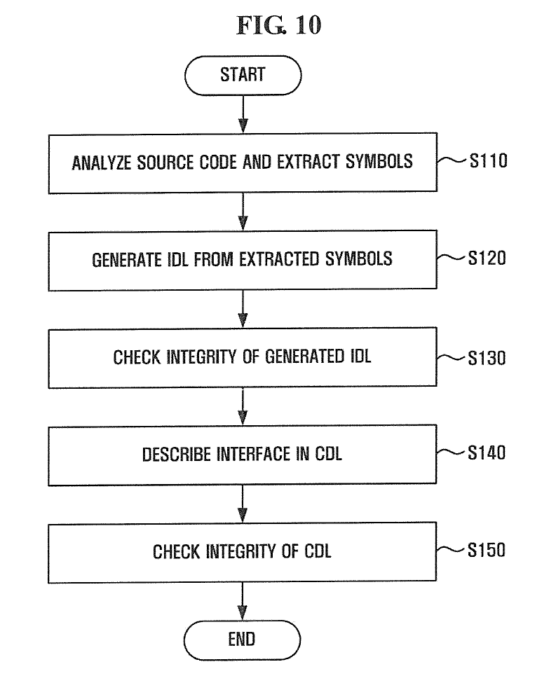

FIG. 10 is a flowchart illustrating a method of generating a functional-level component according to an embodiment of the present invention. The component division module 111 analyzes source code and extracts symbols (operation S110). The language generation module 112 generates the IDL from the extracted symbols (operation S120).

The integrity check module 113 checks integrity of the generated IDL (operation S130) and describes a newly generated interface or a previously registered interface in CDL (operation S140). The integrity check module 113 checks the integrity of the CDL (operation S150).

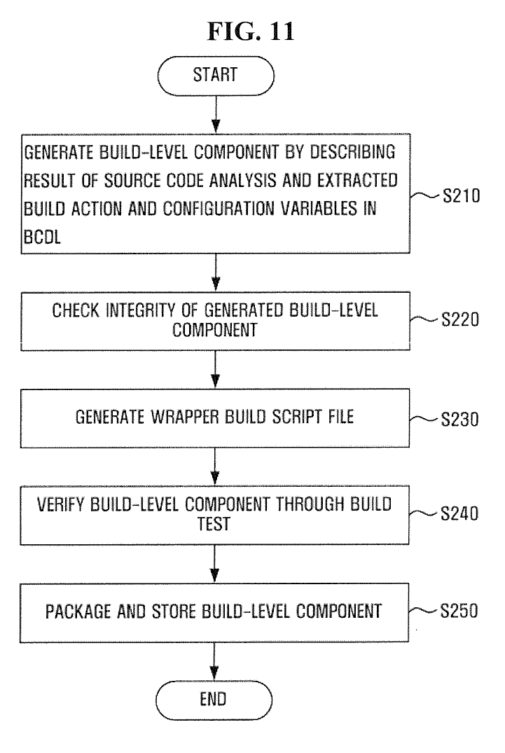

FIG. 11 is a flowchart illustrating a method of generating a build-level component according to an embodiment of the present invention. A build-level component is generated in BCDL by describing the result of source code analysis and information regarding a build action and configuration variables divided by the component division module 111 (operation S210).

The integrity check module 113 checks the integrity of the generated build-level component (operation S220). The build script generation module 115 generates a wrapper build script file, which can build a component, based on the BCDL verified in the integrity check process (operation S230). The build script generation module 115 sets the generated build-level component to various configuration values based on a configuration interface described in BCDL and verifies the build-level component through a build test (operation S240). The verified build-level component is specified to be related to the implementation of a corresponding functional-level component, packaged, and stored in the storage module 116 (operation S250).

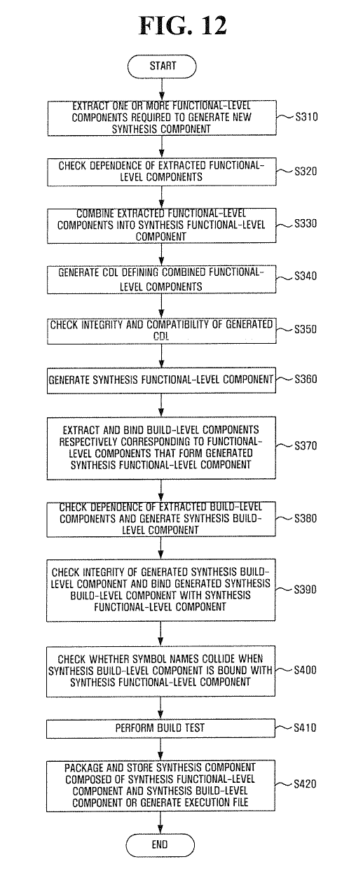

FIG. 12 is a flowchart illustrating a method of generating a synthesis component according to an embodiment of the present invention. The component combination module 117 extracts one or more functional-level components required to generate a new synthesis component from the storage module 116 (operation S310).

The component combination module 117 checks the dependence of the extracted functional-level components (operation S320). The component combination module 117 checks components depended on by the extracted functional-level components to execute. The component combination module 117 combines the extracted functional-level components and thus combines synthesis functional-level components (operation S330). The language generation module 112 generates a CDL defining the generated and combined functional-level components (operation S340).

The integrity check module 113 checks the integrity and compatibility of the generated CDL (operation S350). The integrity check module 113 performs the compatibility check in order to determine whether the functional-level components are properly combined with each other. In addition, the integrity check module 113 checks whether all interfaces that form the functional-level component actually exist.

After the integrity and compatibility checks are completed, the component combination module 117 generates a synthesis functional-level component (operation S360). In addition, the component combination module 117 extracts build-level components corresponding to the functional-level components that form the generated synthesis functional-level component from the storage module 116, and binds the extracted build-level components (operation S370). The component combination module 117 checks the dependence of the extracted build-level component and, if no error is found, generates a synthesis build-level component (operation S380).

The integrity check module 113 checks the integrity of the generated synthesis build-level component. If no error is found, the integrity check module binds the generated synthesis build-level component with the synthesis functional-level component (operation S390).

When binding the synthesis functional-level component with the synthesis build-level component, the component combination module 117 checks whether their symbol names collide (operation S400). The build script generation module 115 generates a wrapper build script file for build and performs a build test by applying various configurations (operation S410).

After performing the build test, the component combination module 117 packages a synthesis component composed of the synthesis functional-level component and the synthesis build-level component and stores the packaged synthesis component in the storage module 116 or generates an execution file to be used on a target platform (operation S420).

The term ‘module’, as used herein, refers to, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

In addition, aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), DVDs, CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, an apparatus and method for developing a component-based software according to aspects of the present invention provide several advantages. A logical function of a component is managed using a functional-level component, and a build-related physical function of the component is managed using a build-level component. Therefore, the component can be easily transplanted to various environments. In addition, when a synthesis component is generated, its integrity is checked. Therefore, discrepancies between what is described in the definition of a component and the actual component can be eliminated.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to develop component-based software, the apparatus comprising:
a component division module to analyze source code and a build file and to divide the analyzed source code and build file into a build-level component and a functional-level component;
an integrity check module to check the integrity of languages defining the build-level component, the functional-level component, and an interface of the functional-level component; and
a component combination module to combine one or more build-level components corresponding to one or more functional-level components that form an architecture.

2. The apparatus of claim 1, further comprising a language generation module to generate the languages.

3. The apparatus of claim 1, wherein the integrity check module checks the integrity of the languages by comparing the languages with the source code.

4. The apparatus of claim 1, further comprising:
a header file generation module to generate a header file using the language defining the functional-level component and the language defining the interface of the functional-level component;
a build script generation module to generate a build script file using the language defining the build-level component; and
a storage module to store the header file and the build script file.

5. The apparatus of claim 4, wherein the component combination module extracts one or more functional-level components required to form the architecture from the storage module, extracts one or more build-level components corresponding to the extracted functional-level components from the storage module, and binds the extracted build-level components with the extracted functional-level components.

6. The apparatus of claim 5, wherein the integrity check module checks the integrity of a synthesis functional-level component including the extracted functional-level components and checks the integrity of a synthesis build-level component comprised of the extracted build-level components.

7. The apparatus of claim 6, wherein the build script generation module generates the build script file for building the synthesis build-level component.

8. A method of developing component-based software, the method comprising:
analyzing source code and a build file and dividing the analyzed source code and build file into a build-level component and a functional-level component;
checking the integrity of languages defining the build-level component, the functional-level component, and an interface of the functional-level component; and
combining one or more build-level components corresponding to one or more functional-level components that form an architecture.

9. The method of claim 8, further comprising generating the languages.

10. The method of claim 8, wherein the checking of the integrity comprises checking the integrity of the languages by comparing the languages with the source code.

11. The method of claim 8, further comprising:
generating a header file using the language defining the functional-level component and the language defining the interface of the functional-level component;
generating a build script file using the language defining the build-level component; and
storing the header file and the build script file.

12. The method of claim 11, wherein the combining of the components comprises:
extracting one or more functional-level components required to form the architecture; and
extracting one or more build-level components corresponding to the extracted functional-level components, and binding the extracted build-level components with the extracted functional-level components.

13. The method of claim 12, wherein the checking of the integrity comprises:
checking the integrity of a synthesis functional-level component including the extracted functional-level components; and
checking the integrity of a synthesis build-level component including the extracted build-level components.

14. The method of claim 13, wherein the generating of the build script file comprises generating the build script file for building the synthesis build-level component.

15. A method of developing stable software having components that are combinable and re-usable without errors, the method comprising:
analyzing source code;
extracting symbols from the source code;
generating an interface definition language (IDL) from the extracted symbols that defines an interface used by the source code; and
checking the integrity of the generated IDL.

16. The method of claim 15, further comprising:
describing the interface in a component definition language; and
checking the integrity of the description.

17. The method of claim 15, wherein the checking of the integrity of the generated IDL comprises:
generating an error if the IDL specifies an interface not implemented in the source code.

18. The method of claim 15, wherein the checking of the integrity of the generated IDL comprises:
generating an error if the source code uses a symbol not specified in the IDL.

19. A method of developing stable software having components that are combinable and re-usable without errors, the method comprising:
generating a build-level component based on source code, a build action, and configuration variables;
checking the integrity of the build-level component;
generating a wrapper build script file based on the build-level component;
verifying the build-level component; and
packaging and storing the verified build-level component.

20. The method of claim 19, wherein the generating of the build-level component comprises:
describing the build-level component in a build-level component definition language (BCDL).

21. The method of claim 20, wherein the generating of the wrapper build script file comprises:
generating the wrapper build script file based on the BCDL.

22. The method of claim 21, wherein the verifying of the build-level component comprises:
setting the build-level component to various configuration files based on a configuration interface specified in the BCDL; and
verifying the build-level component through a build test.

23. A computer readable medium comprising instructions that, when executed by a processor, cause the processor to perform the method of claim 8.

24. A computer readable medium comprising instructions that, when executed by a processor, cause the processor to perform the method of claim 15.

25. A computer readable medium comprising instructions that, when executed by a processor, cause the processor to perform the method of claim 19.

26. The apparatus of claim 6, wherein the component combination module packages a component comprising at least one synthesis functional-level component and stores the component in the storage module.

27. The apparatus of claim 6, wherein the component combination module packages a component comprising at least one synthesis build-level component and stores the component in the storage module.
